(19) United States
(12) Patent Application Publication
(10) Pub. No.: US 2013/0108146 A1
(43) Pub. Date: May 2, 2013

(54) Method and System for Optical Inspection Using Known Acceptable Dies

(71) Applicant: Shang-Chian Li, Chiayi County (TW)

(72) Inventor: Shang-Chian Li, Chiayi County (TW)

(73) Assignee: TAIWAN SEMICONDUCTOR MANUFACTURING COMPANY, LTD., Hsinchu (TW)

(21) Appl. No.: 13/286,340

(22) Filed: Nov. 1, 2011

(51) Int. Cl. G06K 9/62

(52) U.S. Cl. 382/144

(57) ABSTRACT

A method includes (a) creating a plurality of patterns on a plurality of dies, the plurality of dies being formed upon a semiconductor wafer, the plurality of patterns being formed so that each of the dies has a different focus and exposure energy value, (b) selecting at least one known acceptable die from the wafer, wherein acceptability is determined at least in part by a critical dimension value and a defect status, (c) using optical inspection, comparing the at least one known acceptable die to a first subset of the plurality of dies, and (d) classifying each die in the first subset as within established limits or outside of the established limits in response to (c).

### BACKGROUND

After Development Inspection (ADI) captures critical dimension information of a patterned photoresist layer, whereas After Etching Inspection (AEI) captures critical dimension information of an etched feature on a semiconductor substrate. A pattern produced on a die may benefit from a certain level of AEI and ADI critical dimension to ensure a lower number of defects.

Some semiconductor processes include testing to determine which values for focus and energy level produce AEI and ADI critical dimension values (and perhaps defect numbers as well) within established limits. One conventional process includes writing a Focus Energy Matrix (FEM) to a wafer and then inspecting the dies of the wafer, where each of the dies is produced with a different value in the FEM, to discern which FEM values produce acceptable dies.

The conventional process includes selecting a known good die (also referred to as a “golden die”) and then comparing the known good die to other dies of the wafer using an electron beam (or e-beam) comparing process. The dies of the wafer can be classified as acceptable or not acceptable by the comparing process. An analysis of the acceptable dies provides information regarding which values for focus and energy should be used when manufacturing production wafers. E-beam inspection processes are generally considered to be sensitive and precise but can be quite slow.

Some conventional processes use an optical inspection for determining which dies are acceptable. These conventional processes optically compare a given die against its immediate neighbors on the wafer, where deviation during the comparison may be an indication of unacceptability. Neighbor-die comparison can be effective at spotting defects that cause large variance between a die and its neighbor in the FEM wafer, but may be less effective at spotting defects that change only incrementally die-to-die over many dies. Optical inspection methods tend to be faster than e-beam inspection methods but may be less sensitive and/or less precise.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is an illustration of an example method for performing FEM wafer testing according to one embodiment.

FIG. 2 is an illustration of an example FEM wafer and an FEM according to one embodiment.

FIG. 3 is an illustration of an exemplary test method adapted according to one embodiment.

FIG. 4 shows an exemplary neighbor-die testing method for use in one embodiment.

FIG. 5 is an illustration of example computing environment for performing one or more of the actions described above according to one embodiment.

FIG. 6 is an illustration of an example wafer inspector 600 adapted according to one embodiment.

### SUMMARY

One of the broader forms of the present disclosure involves a method that includes (a) creating a plurality of patterns on a plurality of dies, the plurality of dies being formed upon a semiconductor wafer, the plurality of patterns being formed so that each of the dies has a different focus and exposure energy value, (b) selecting at least one known acceptable die from the wafer, wherein acceptability is determined at least in part by a critical dimension value and a defect status, (c) using optical inspection, comparing the at least one known acceptable die to a first subset of the plurality of dies, and (d) classifying each die in the first subset as within established limits or outside of the established limits in response to (c).

Another of the broader forms of the present disclosure involves a system for testing in a semiconductor manufacturing process that includes a wafer inspector for receiving a Focus Energy Matrix (FEM) wafer and selecting at least one known good die from a plurality of dies on the wafer. The wafer inspector includes an optical analysis module for generating images of the plurality of dies according to an optical inspection process, and a comparator module for receiving the images and comparing one or more images of the at least one known good die to images of other dies of the plurality of dies, the comparator module further operable to classify one of the other dies as within acceptable limits or outside of acceptable limits based on the comparing.

Another of the broader forms of the present disclosure involves a computer program product having a computer readable medium tangibly recording computer program logic for performing testing in a semiconductor manufacturing environment, the computer program product includes code to create a plurality of patterns on a plurality of dies, the plurality of dies being formed upon a semiconductor wafer, the plurality of patterns being formed according to a Focus Energy Matrix (FEM) so that each of the dies is formed having a different FEM value, code to select at least one known acceptable die from the wafer, wherein acceptability is determined at least in part by a critical dimension value and a defect status, code to compare the at least one known acceptable die to other dies on the wafer using optical inspection, and code to classify each of the other dies as within established limits or outside of the established limits in response to the optical inspection.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Various embodiments disclosed herein provide for an optical inspection method that includes a golden die comparison process. Furthermore, various embodiments may also include an optical neighbor-die comparison as well, which when used with the optical golden die comparison process can provide a high level of sensitivity for FEM wafer testing within the same recipe.

An example method includes manufacturing an FEM wafer by depositing and patterning a photoresist layer on the wafer to produce certain prescribed features. After the photoresist layer is developed, the ADI critical dimension of the individual cells is measured. Exposed portions of the wafer may then be removed by, e.g., etching processes, and then the photoresist layer is removed by, e.g., ashing and dissolving the photoresist material.

After the photoresist material is removed, the features of the wafers are exposed, and the process continues by measuring AEI critical dimension for each of the respective dies. One or more golden dies are then selected. For instance, with AEI and ADI critical dimension values for each of the dies being known, a particular die with acceptable AEI and ADI values may be selected and checked for defects. If the die has an acceptable defect status it may be selected as a golden die. If the die has an unacceptable defect status, the process may continue by checking for defects in another die and, if appropriate, selecting the other die as a golden die.

The process may select as many golden dies as is desirable. For instance, a certain number of dies in a row or a column or in another arbitrary spatial relationship may be selected as golden dies.

Other dies in the wafer, either all of the other dies or some subset of the other dies, are compared against the golden dies using an optical inspection process. In an example inspection process, a machine compares images of tested dies against images of golden dies using visible light or ultraviolet (UV) light. The comparison is used to identify defects in the tested dies, where differences in the images are assumed to be defects.

The testing process yields information regarding which of the dies are acceptable and which of the dies are unacceptable. In fact, AEI critical dimension values, ADI critical dimension values, defect status, and any other appropriate factors may be used in identifying a die as acceptable or unacceptable. Information from the test may be used to discern which values in the FEM are better than others at producing good dies in production wafers. The method may continue by fabricating production wafers using FEM values that were vetted during FEM wafer testing.

As mentioned above, the example process does not preclude the use of neighbor-die comparisons. In fact, neighbor-die comparisons may be performed before or after the golden die comparisons are performed to add sensitivity to the testing technique.

Various embodiments may include hardware and software to implement the example method described above. For instance, one or more computer-based inspection machines may be used to measure AEI critical dimension values, ADI critical dimension values, and defects and to process the information to identify values in the FEM for use during production. Also, any appropriate semiconductor fabrication tools may be used to deposit and pattern the photoresist layer and to etch the exposed portions of the wafer.

Additional embodiments include computer program products including code stored to non-transitory computer readable media, where the code when executed performs one or more of the method steps described above. Various embodiments are described in more detail below.

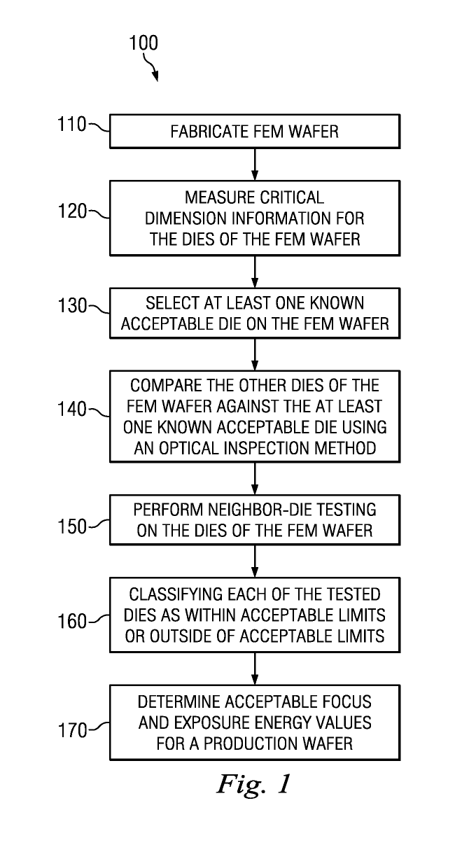

FIG. 1 is an illustration of an example method 100 for performing FEM wafer testing according to one embodiment. Method 100 may be performed by one or more tools in or more fabrication facilities.

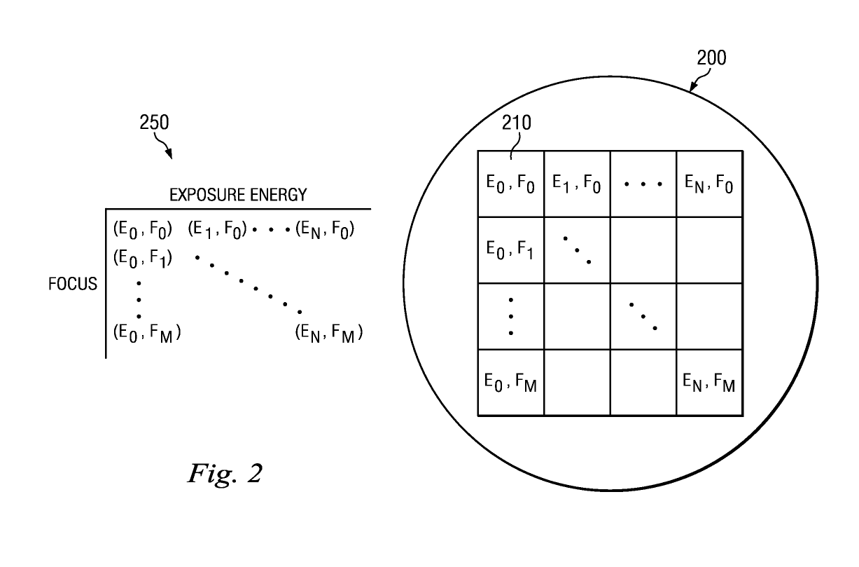

At block 110, the FEM wafer is fabricated. An example FEM wafer 200 and an FEM 250 are shown in FIG. 2. FEM 250 is a table of exposure energy and focus values for use during photoresist patterning. A particular value from an entry in FEM 250 is represented here by (E,F). In the x-direction of FEM 250, exposure energy incrementally changes with each entry. Similarly, in the y-direction of FEM 250, focus incrementally changes with each entry.

Continuing with FIG. 2, FEM wafer 200 can be any kind of wafer at any fabrication step. For instance, any appropriate substrate material, film, or feature material (e.g., oxide, metal, or the like) may be included in wafer 200.

Wafer 200 includes a multitude of dies, one of which is exemplified by die 210. Wafer 200 is shown with only sixteen dies thereon, and it is understood that the example of FIG. 2 is provided for ease of illustration. The scope of embodiments is not limited to any number of dies on a wafer or any size wafer. Furthermore, the dies are shown only in the center of wafer 200, but it is understood that in various embodiments, the entire surface, or nearly the entire surface, of wafer 200 hosts dies.

The size of FEM 250 may be any appropriate size, but in this example is commensurate with the number of rows and columns of dies to be tested in wafer 200. A given entry in FEM 250 corresponds to one of the dies of wafer 200, and each of the dies of the wafer 200 has a different (E,F) value. The (E,F) values may be generated automatically or manually using any appropriate algorithm.

Photoresist material is applied to wafer 200 by, e.g., spin coating. The photoresist material is then patterned by a lithography process including exposure and development. The photoresist material is exposed by application of intense light through a photomask. In one example, UV light is passed through a mask and onto the surface of the wafer at a particular intensity for a particular time and at a particular focus value. For each of the dies (e.g., die 210) of wafer 100, energy is applied according to its respective (E,F) value. Thus, in one direction, energy values applied to the dies incrementally increases or decreases die-to-die. Similarly, in the other direction, focus changes incrementally die-to-die. The result is an FEM wafer 200 with a multitude of dies thereon that are each treated differently in this photolithography process. Further in this example, the same pattern is produced on each die.

An etching process is then performed on the exposed portions of the wafer surface. For instance, the etching may remove substrate material, metal, dielectric film, and/or the like from the wafer using any appropriate technique. The photoresist material is then stripped using, e.g., an ashing and solvent process.

Returning to FIG. 1, in block 120 critical dimension information is measured for each of the dies of the wafer. In one example, an ADI critical dimension is measured after the photoresist is patterned but before etching is performed. Further in this example, an AEI critical dimension is measured after the etching is performed and the photoresist is stripped. Values for ADI and AEI critical dimension for each of the dies are stored.

In block 130, one or more known acceptable dies (golden dies) are selected from the multitude of dies on the wafer. Every die has been treated differently during the photolithography process, and AEI and ADI critical dimension values will vary among the dies. In one example embodiment, a computer selects the golden dies based, at least in part, on AEI and ADI critical dimension values from block 120.

Before a die is selected as a golden die in this example it is confirmed as acceptable by a defect test. For instance, the selected die may be examined closely to verify that it is defect-free, or at the least, that it has no significant defects that would affect performance of a production die. If the die passes the defect test, it may be designated as a golden die.

On the other hand, if the die shows significant defects it may be rejected as a golden die, and another die may be selected and tested instead. In any event, more than one golden die may be selected. For instance, the (E,F) values change only incrementally die-to-die, and the dies immediately surrounding a known good die can usually also be expected to have similar characteristics. Thus, one example embodiment includes selecting multiple golden dies in the same row or column (or even multiple, adjacent rows or columns) subject to a defect test, of course.

In block 140, the other dies of the FEM wafer are compared against the known acceptable dies using an optical inspection method. The optical inspection method is described in more detail below with respect to FIGS. 5 and 6. But in short, the optical inspection method includes scanning the known acceptable dies and also scanning other dies of the wafer using optical light. The scanned images of the golden dies are compared to the scanned images of the other dies and differences in the scanned images are noted.

Some differences in the scanned images may be minor, whereas other differences may be more significant. As long as the differences are within some predetermined threshold, a given die may be classified as acceptable. If the differences exceed the predetermined threshold, the die may be classified as not acceptable. In any event, other tests may be performed (e.g., as described in block 150) before a die is finally classified as acceptable or not acceptable.

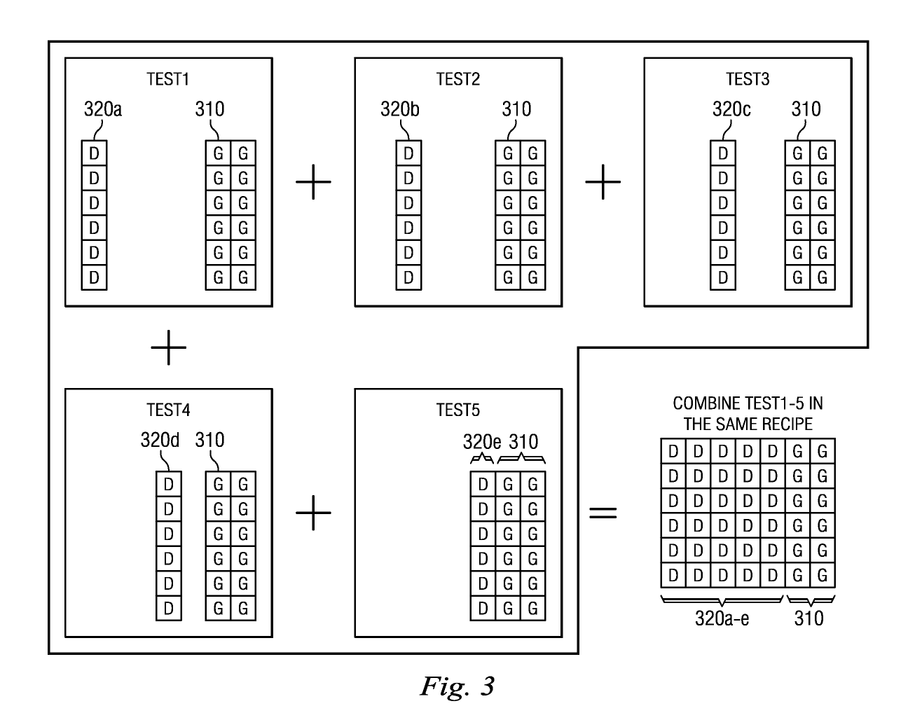

FIG. 3 is an illustration of an exemplary test method adapted according to one embodiment. Golden dies are shown as dies 310, whereas testing dies are shown as dies 320. In this example, golden dies 310 are selected as two adjacent columns. In each successive test, an adjacent column 320 is tested against the golden dies 310. Thus, in test 1, column 320a is tested, in test 2, column 320b is tested, etc.

FIG. 3 shows five tests for five different testing columns 320a-e against golden dies 310. Testing for a given die may be accomplished in any acceptable manner, though in this particular embodiment a given die is tested against the two golden dies in its respective row. The dies in a column may be tested simultaneously or sequentially, and the scope of embodiments is not limited to any particular order for testing or any particular number of tests to be performed simultaneously. Furthermore, block 140 (FIG. 1) may include testing all of the other dies against the golden dies or may include testing fewer than all of the dies, as may be appropriate.

Embodiment that select multiple golden dies and perform tests at the same time may see increased efficiency, though the amount of processing power used may be greater than that of a system that tests one die at a time.

The scope of embodiments is not limited to selecting golden dies in rows or columns. In another example only a single golden die is selected. In yet another example, non-adjacent dies are selected as golden dies. Various embodiments may use any appropriate selection of golden dies.

Some embodiments may perform golden die testing and may forgo other defect testing algorithms. However, other embodiments may perform additional types of defect testing in addition to golden die testing in order to increase sensitivity to defects. The present embodiment includes block 150 in which neighbor-die testing is also performed on the dies.

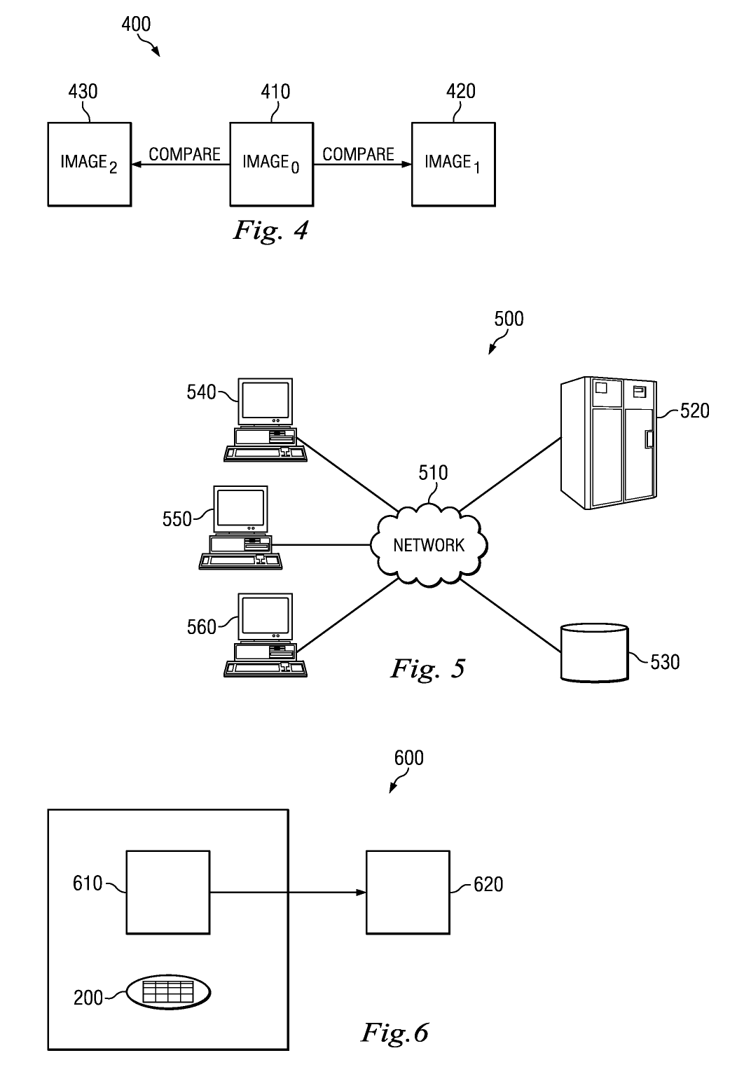

FIG. 4 shows an exemplary neighbor-die testing method 400 for use in one embodiment. In the example method 400, the center die 410 is compared to its immediate neighbors 420, 430 on the right and the left using an optical testing method. Center die 410 has image 0, die 320 has image 1, and die 430 has image 2. Image 0 is optically compared to images 1 and 2, and any differences are noted. The method then moves to the next die and compares the next die against its immediate neighbors. The method repeats until an appropriate number of dies in the FEM wafer have been tested.

The scope of embodiments is not limited to testing a die against its neighbors within a row, as some embodiments may test a neighbor against other dies in its same column or even against dies that are not adjacent but instead may be separated by one die from the die under test. In fact, any neighbor-die testing algorithm can be used in some embodiments.

Neighbor-die testing can find unique defects efficiently and accurately in some instances. However, defects that are repeated die-to-die may not be found reliably. Nevertheless, adding neighbor-die testing to golden die testing adds sensitivity to the overall testing regimen in some embodiments.

In block 160, each of the tested dies is classified as within acceptable limits or outside of acceptable limits. Block 160 may include examining any number of factors relevant to fabrication of the die. For instance, block 160 may take AEI and ADI critical dimension values into account in addition to defect inspection. Furthermore, block 160 may include a simple threshold for defects or may include a more robust algorithm that places more weight on some defects and less weight on others. The set of parameters and thresholds may be set in any manner appropriate for a given application.

In some embodiments, golden die testing is used exclusively, and block 160 may include analyzing defect testing results only from golden die testing. However, other embodiments may include other types of defect testing, such as neighbor-die testing, and such embodiments may include in block 160 considering those defect testing results too.

In block 170, acceptable focus and exposure energy values are determined for a production wafer based on the previous steps in method 100. For instance, block 160 includes classifying some dies as within acceptable limits or outside of acceptable limits. Some embodiments include correlating the dies that are within acceptable limits with their respective (E, F) values, where those (E, F) values are deemed acceptable.

The scope of embodiments is not limited to the exact steps shown in FIG. 1. Other embodiments may add, omit, rearrange, or modify one or more actions as appropriate. For instance, some embodiments may repeat method 100 for subsequent, different recipes.

Also some embodiments further include applying the information gained from method 100 to the manufacture of production wafers. For instance, some embodiments include using those (E, F) values determined in block 170 during photolithography processes for production wafers.

Embodiments of the present disclosure can take the form of a computer program product accessible from a tangible computer-usable or computer-readable medium providing program code for use by or in connection with a computer or any instruction execution system. For the purposes of this description, a tangible computer-usable or computer-readable medium can be any apparatus that can store the program for use by or in connection with the instruction execution system, apparatus, or device. The medium can be an electronic, magnetic, optical, electromagnetic, infrared, or a semiconductor system (or apparatus or device).

The present disclosure provides for many different embodiments. In an example, a system includes hardware and software to implement the actions described above. FIG. 5 is an illustration of example computing environment 500 for performing one or more of the actions described above according to one embodiment.

The computing environment 500 includes a network 510, which provides a medium through which various devices and computers in the computing environment can communicate. The network 510 may include connections such as wires, wireless, and/or fiber optic cables. The network 510 may further the Internet and/or a collection of networks and gateways that use such things as a Transmission Control Protocol/Internet Protocol (TCP/IP) or other suitable protocols to communicate with. In another example, the network 510 may include a number of different types of networks such as a local area network (LAN), or a wide area network (WAN).

The computing environment 500 further includes a server 520, a storage unit 530, and a plurality of clients 540, 550, 560. The plurality of clients 540, 550, 560 may include workstations, personal computers, or other suitable devices. The server 520 may provide applications and/or data stored in the storage unit 530 to the clients 540, 550, 560. Furthermore, the computing environment 500 may include additional nodes, such as additional servers, clients, and other devices not shown herein. FIG. 5 is intended to be a mere example, and not as an architectural limitation for the present disclosure.

In a more specific example, the method 100 of FIG. 1 and system 600 of FIG. 6 (described below) may be implemented with the computing environment 500. The clients 540, 550, 560 may be associated with the wafer inspectors and the comparator as described in FIG. 6. The server 520 may provide the required data and/or software applications to the clients 540, 550, 560 to implement the method 100 of FIG. 1. The server 520 may also retrieve and store defect data generated by a comparator application as well as image data generated by the wafer inspectors. Additionally, other clients such as manufacturing tools may communicate via the network 510 to receive data regarding acceptable (E, F) values for use in manufacturing production wafers.

FIG. 6 is an illustration of an example wafer inspector 600 adapted according to one embodiment. As described in more detail below, optical analysis module 610 uses light to scan images of the various dies on FEM wafer 200 and sends the images to comparator 620, which performs defect testing by comparing the images. Wafer inspector 600 may be associated with one or more of the clients 540, 550, 560 of FIG. 5 so that any of the electronic processing may be performed by a computer in computing environment 500.

Wafer 200 may be loaded into wafer inspector 600 to scan an image of the wafer 600. Various optical wafer scanning systems may be used such as an optical microscope system, a laser microscope system, or other suitable optical imaging systems that use visible light or UV light (e.g., deep UV light). The wafer inspector 600 may operate as a stand alone station and independent of other components in computer environment 500 or may be integrated with one of the clients 540, 550, 560 or server 520. Even though only one wafer inspector 600 is disclosed herein, it is understood that any number of wafer inspectors may be implemented in the computing environment 500 and may depend on a size and configuration of the semiconductor fabrication facility.

The optical analysis module 610 for scanning the images of the wafer 200 may include a single- or multiple-objective lens system. The multiple-objective lens system may include a first objective lens for scanning the image of the wafer 200 and additional objective lenses for scanning other wafers (not shown). The optical analysis module 610 grabs images scanned by the objective lenses simultaneously. Alternatively, the optical analysis module 610 may include a single-objective lens system for scanning a single wafer at a time. The scope of embodiments is not limited to any number of objective lens systems. It is understood that the lens systems described herein are mere examples, and that other types of lens systems may be used that generate high resolution images of patterned-wafers.

The wafer inspector 600 scans the golden dies and generates images of the golden dies. The wafer inspector 600 also scans the other dies (the tested dies) of the FEM wafer 200 and generates images thereof. The wafer inspector 600 further includes a comparator 620. The comparator 620 includes software and hardware that is necessary for running an application program to compare the images of the golden dies to the tested dies. For example, the comparator 620 may include a computer or processor that may be coupled to the wafer inspector 600 by a data bus. The images may be generated in an electronic format and may be transferred via the data bus to the comparator 620. The comparator 620 may input the images to an application program where an algorithm compares the images to detect differences between the images.

As mentioned above, the images of the golden dies and the images of the tested dies may be in an electronic format. For the sake of example, each of the images may be formatted in an array of pixels, where each pixel represents a specific location of the image and includes an intensity value. For example, the intensity value may increase as the brightness of the pixel increases. The number of pixels in the array may vary and may depend on a resolution capability of the optical analysis module. The application program may use an algorithm that goes through the array of pixels of both the golden dies and the tested dies and compares the corresponding intensity values of each pixel. Accordingly, the tested dies and the golden dies are compared to each other. It is understood that other types of values may be used to represent each pixel such as a color value (e.g., red component value, green component value, and blue component value).

After scanning, the method continues in which differences between the golden dies and tested dies may be classified and reported as a potential defect of one or more tested dies. As discussed above, for each pixel (at the same location) of a golden die image and a tested die image, their corresponding intensity values may be compared. If the values differ by a pre-determined amount, the pixel and its location may be marked to identify the difference. If the values do not differ by the pre-determined amount, the pixel and its location may not be marked. The application program may classify and report the identified difference as a potential defect on the tested die. It is understood that the pre-determined amount may vary and may be determined by the type of scanning system that is used. Additionally, the pre-determined value may be provided by the fabrication facility using its experience in recognizing and identifying these types of defects on dies.

In one example, there is an area of an image of a tested die that is different from a corresponding area of an image of a golden die. The algorithm compares the images to detect the difference as was previously described. The comparator 620 may report the difference as a potential defect on the tested die. The comparator 620 may further report a location on the tested die that corresponds to the location of the detected difference. The tested die may or may not be disqualified as appropriate according to the classifying algorithm of block 160 (FIG. 1).

It is understood that the wafer inspection system 600 is described above as comparing the tested dies to the golden dies, but that wafer inspection system 600 may include other functions as well. For instance, wafer inspection system 600 may also perform any of the functions of blocks 110-170 of FIG. 1, including but not limited to selection of golden dies and neighbor-die testing as well as measuring critical dimension values.

It is understood that the images of the golden dies may be stored as a reference for comparing with any subsequent tested dies. Furthermore, the image of the golden die may be captured at several different stages following exposure by photolithography.

Various embodiments may include one or more advantages over conventional systems. For instance, some conventional systems use an optic neighbor-die technique only. Various embodiments using a golden die comparison technique alternatively to, or in addition to, a neighbor-die technique and may have increased sensitivity compared to neighbor-die only systems.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
(a) creating a plurality of patterns on a plurality of dies, the plurality of dies being formed upon a semiconductor wafer, the plurality of patterns being formed so that each of the dies has a different focus and exposure energy value;
(b) selecting at least one known acceptable die from the wafer, wherein acceptability is determined at least in part by a critical dimension value and a defect status;
(c) using optical inspection, comparing the at least one known acceptable die to a first subset of the plurality of dies; and
(d) classifying each die in the first subset as within established limits or outside of the established limits in response to (c).

2. The method of claim 1 further comprising:
(e) using optical inspection, comparing each die of a second subset of the plurality of dies to its respective, immediate neighbor; and
(f) classifying each die in the second subset as within the established limits or outside of the established limits in response to (e).

3. The method of claim 1 in which the at least one known acceptable die comprises a third subset of the plurality dies, and in which (c) comprises comparing groups within the first subset to the third subset.

4. The method of claim 1 in which the critical dimension comprises a critical dimension of a photolithography process and a critical dimension of a wafer etch process.

5. The method of claim 1 in which the optical inspection utilizes at least one of deep ultraviolet or visible light wavelengths.

6. The method of claim 1 in which the dies are formed according to a Focus Energy Matric (FEM), and in which the FEM comprises a table of values wherein a value for focus is incrementally adjusted across a first dimension of the table and wherein an energy value is incrementally adjusted across a second dimension of the table.

7. The method of claim 1 further comprising:
analyzing results of (d) to discern appropriate focus and energy values for production wafers; and
manufacturing production wafers according to the appropriate focus and energy values.

8. The method of claim 1 in which the optical inspection comprises creating pixel-based images of the at least one known acceptable die and the first subset of the plurality of dies.

9. A system for testing in a semiconductor manufacturing process, the system comprising:
a wafer inspector for receiving a Focus Energy Matrix (FEM) wafer and selecting at least one known good die from a plurality of dies on the wafer, the wafer inspector including:
an optical analysis module for generating images of the plurality of dies according to an optical inspection process; and
a comparator module for receiving the images and comparing one or more images of the at least one known good die to images of other dies of the plurality of dies, the comparator module further operable to classify one of the other dies as within acceptable limits or outside of acceptable limits based on the comparing.

10. The system of claim 9 in which the wafer inspector is associated with a client computer in a computer network in a wafer fabrication facility.

11. The system of claim 9 in which the optical analysis module uses at least one of visible light or ultraviolet (UV) light to generate the images of the plurality of dies.

12. The system of claim 9 in which the optical analysis module generates the images of the plurality of dies as arrays of pixels.

13. The system of claim 12 in which the comparator compares pixel-by-pixel the one or more images of the at least one known good die to the images of other dies of the plurality of dies.

14. The system of claim 9 in which the wafer inspector selects the at least one known good die based at least in part on critical dimension information and defect status.

15. A computer program product having a computer readable medium tangibly recording computer program logic for performing testing in a semiconductor manufacturing environment, the computer program product comprising:
code to create a plurality of patterns on a plurality of dies, the plurality of dies being formed upon a semiconductor wafer, the plurality of patterns being formed according to a Focus Energy Matrix (FEM) so that each of the dies is formed having a different FEM value;
code to select at least one known acceptable die from the wafer, wherein acceptability is determined at least in part by a critical dimension value and a defect status;
code to compare the at least one known acceptable die to other dies on the wafer using optical inspection; and
code to classify each of the other dies as within established limits or outside of the established limits in response to the optical inspection.

16. The computer program product of claim 15 further comprising:
code to pass information regarding which of the other dies are within established limits to production tools.

17. The computer program product of claim 15 in which the code to create a plurality of patterns comprises:
code to perform a photolithography process on the wafer according to the FEM.

18. The computer program product of claim 15 in which the code to select the at least one known acceptable die comprises:
code to select multiple known acceptable dies in multiple columns or rows of the wafer.

19. The computer program product of claim 15 in which the code to compare comprises:
code to apply light to the wafer to generate a plurality of pixel images of the plurality of dies.

20. The computer program product of claim 19 in which the code to compare further comprises:
code to compare the at least one known acceptable die to other dies pixel-by-pixel in the pixel images.
